(19) United States
(12) Patent Application Publication
(10) Pub. No.: US 2006/0220448 A1
(43) Pub. Date: Oct. 5, 2006

(54) Chassis bearing

(76) Inventors: Volker Härtel, Germering (DE); Hans-Jürgen Karkosch, Hemmingen (DE); Armin Kilsch, Hannover (DE); Heiner Volk, Neustadt (DE); Hans-Joachim Harting, Hemmingen (DE); Meinert Holst, Barsinghausen (DE)

Correspondence Address: WALTER OTTESEN, PO BOX 4026, GAITHERSBURG, MD, 20885-4026, US

(21) Appl. No.: 10/563,760

(22) PCT Filed: Apr. 28, 2004
(86) PCT No.: PCT/EP04/04494

§ 371 Date: Mar. 15, 2006

(30) Foreign Application Priority Data
Jul. 9, 2003 (DE) 10330877.6

(51) Int. Cl. B60T 13/18

(52) U.S. Cl. 303/11; 188/353

(57) ABSTRACT

The invention relates to a chassis bearing (1), in particular for the rear axle of a motor vehicle. The bearing includes an outer bearing sleeve (2), an inner bearing sleeve (3), an elastomer body (4) that is situated between the outer and inner bearing sleeves and two chambers (5, 6), which are located between the outer and inner bearing sleeves and are delimited at least partially by the elastomer body. The chambers are separated from one another and are positioned symmetrically on either side of the longitudinal axis (7) of the inner bearing sleeve. Each chamber has a stop (8, 9), which is located on a common transverse axis (10) of the inner bearing sleeve and is positioned at a distance from a corresponding counterstop surface (11, 12) inside the chamber. According to the invention, the stops are configured so that they can be displaced and subjected to a pressure in such a way that they are displaced along the common transverse axis, fixing the inner bearing sleeve in relation to the outer bearing sleeve during any vibrations or oscillations. The pressure required to fix the stops is only completely built up when both stops rest against their counterstop surfaces.

The invention relates to a chassis bearing according to the preamble of claim 1.

Conventional chassis bearings, especially for the rear axle of a motor vehicle, include an elastomer body of rubber which is held in the chassis. The elastomer body includes a central, inner lying bushing in the form of an inner bearing sleeve having a bolt guided therein which is connected to the wheel suspension. In other chassis bearings with the same configuration, the bolt is held in the chassis and the elastomer body is connected to the wheel suspension. The elastomer body is usually surrounded by a housing in the form of a one-part or multi-part outer bearing sleeve.

With conventional chassis bearings of this kind, vibrations of the wheel suspension are damped relative to the chassis with the damping being dependent upon the characteristics of the elastomer body.

Chassis bearings of the type mentioned initially herein can have chambers which are arranged between the outer and inner bearing sleeves and are delimited, at least partially, by the elastomer body. The chambers are separated from each other and are mounted symmetrically on both sides of the longitudinal axis of the inner bearing sleeve. The longitudinal axis of the inner bearing sleeve runs vertically after the completed assembly of the chassis bearing in the vehicle. The chambers usually each have a stop which is arranged on a common transverse axis of the inner bearing sleeve at a distance to the corresponding counterstop surface within the chamber. The transverse axis points in the travel direction in the vehicle after the assembly of the chassis bearing.

A softly matched chassis bearing is desirable for a comfortable trip with a motor vehicle. If a force acts in the travel direction on a chassis bearing of this kind, which is completely mounted, then this force is damped up to a specific maximum oscillation amplitude for a soft matching. For larger oscillation amplitudes, which occur, for example, when braking a vehicle, especially when passing through resonance, stop and counterstop can bump against each other. In this case, a hard matched chassis bearing is desirable. Basically, chassis bearings having a high bearing stiffness are used in order to hold the oscillation amplitude as low as possible when passing through resonance.

Chassis bearings are already known from DE 40 36 538 A1 and DE. 100 49 140 A1 whose stiffness is controllable in dependence upon the traveling state. DE 40 36 538 A1 discloses an aggregate bearing which can also be used for a stiffness circuit on the bushing bearing of a chassis. The aggregate bearing includes two spring elements. One spring element is continuously active and the other spring element can be switched in via a control unit in dependence upon the travel operating state. The spring element, which can be switched in, becomes effective via an actuating element. In this way, to increase the stiffness of the aggregate bearing, a membrane is charged by a pressure medium via a pressure connection whereby a support part is moved out of its original position in a direction toward one of the two effective spring elements and comes there in contact engagement. The one of the two spring elements is thereby no longer effective so that the stiffness of the aggregate bearing is increased. DE 100 49 140 A1 describes a chassis bearing which can be switched into a higher stiffness in dependence upon the travel state of the vehicle. The increase of the stiffness takes place by switching in a second bearing. In the switched condition, the first bearing is connected in parallel to the second bearing whereby the spring rates add up to a higher total stiffness.

It is disadvantageous with the above-mentioned switchable chassis bearings that they have a very costly and complex assembly. In each case, two spring systems connected in parallel or connected in series are required.

Starting from the state of the art, the invention is based on the task to equip a chassis bearing of the kind referred to initially herein to make the same easily switchable so that the bearing stiffness can be increased by a multiple at any time.

This task is solved in a chassis bearing according to the preamble of claim 1 via the features given in the characterizing part of claim 1. Further embodiments and advantageous configurations of the invention result from the dependent claims.

According to the invention, the stops are configured so as to be displaceable and can be so charged with pressure that they are displaced along the common transverse axis and fix the inner bearing sleeve relative to the outer bearing sleeve in an instantaneous oscillating state. The pressure required for fixing can only then be completely built up when both stops lie on their counterstop surfaces.

With a chassis bearing, which is configured in this manner, the bearing stiffness can be increased by a multiple at any time. Here, it is essential to the invention that, on the one hand, two displaceable stops are provided in order to clamp the inner bearing sleeve and to fix the inner bearing sleeve in its instantaneous oscillating state relative to the outer bearing sleeve and that, on the other hand, the pressure, which is required for fixing, is only completely built up when both stops lie on their counterstop surfaces. With the latter, it is achieved that the inner bearing sleeve, which oscillates relative to the outer bearing sleeve, is not displaced relative to the outer sleeve via one of the stops. Only when both stops lie against their counterstop surfaces, can the stops be charged with the pressure required for fixing. Only at this moment, the inner bearing sleeve is fixed in its position or in its instantaneous oscillating state assumed at this time point.

As soon as the stops impact on the counterstop surfaces, they can press against the counterstop surfaces with a force of up to 10,000 Newton so that a stiffness jump of the chassis bearing and an increase of the stiffness can be reached by at least a multiple of 16.

If the stops are, for example, charged with such a high pressure during braking, the chassis resonance can be displaced into favorable regions and passing through unfavorable chassis resonances can be avoided.

Advantageously, the basic stiffnesses of the chassis bearings of the invention can be configured very much softer than the stiffnesses of the conventional chassis bearing. In this way, a better driving comfort is achieved.

A further embodiment of the invention provides that the stops each have a pressure medium connection. The pressure medium connections are connected to each other and have a common supply line for the pressure medium. The connection of the pressure medium connections leads to a uniform pressure charge of the stops in the manner of communicating tubes and prevents that a stop, which has already come to rest against the counterstop surface, leads to a displacement of the inner bearing sleeve relative to the outer bearing sleeve. Rather, the inner bearing sleeve oscillates relative to the outer bearing sleeve so long until both stops lie on their counterstop surfaces. Only then is a maximum pressure built up via the pressure medium connections. At this instant, the instantaneous oscillating state of the inner bearing sleeve relative to the outer bearing sleeve is fixed.

Preferably, the pressure medium connection is a hydraulic connection and the pressure medium is a corresponding hydraulic medium. Advantageously, the hydraulic system of the braking arrangement, which is usually already available in the vehicle, is can be used.

According to the invention, it has especially been shown to be advantageous when the stop is mounted within the chamber on the side facing toward the outer bearing sleeve and the corresponding counterstop surface is mounted within the chamber on the side facing toward the inner bearing sleeve. In an arrangement of this kind, the pressure medium connections for displacing the stops are especially easy to realize.

Furthermore, it is provided that the chassis bearing includes means for resetting the stops. It is practical when the means is a return spring, preferably, a rubber spring.

According to an advantageous embodiment of the invention, the stop is configured as an actuating piston operating against a reset spring.

In the following, the invention will be explained with reference to an embodiment which is shown in the drawings. In the drawings:

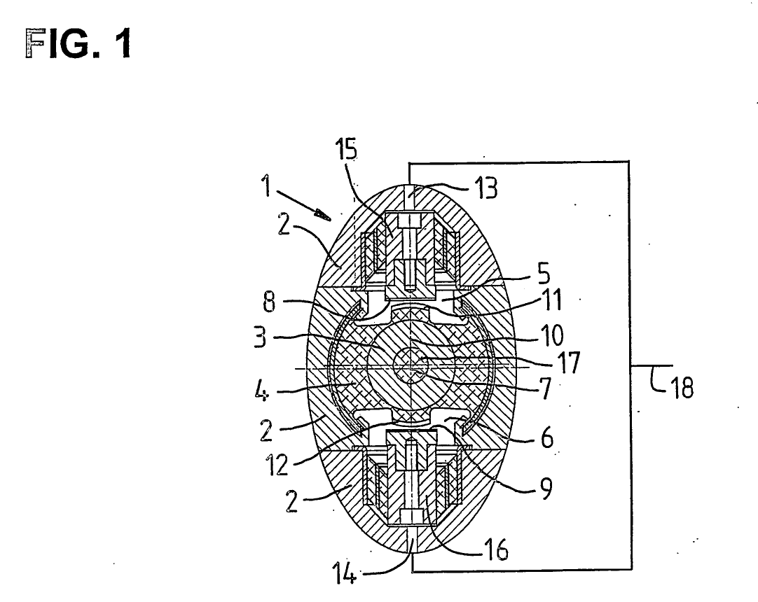

FIG. 1 shows a schematic horizontal longitudinal section through the chassis bearing according to the invention; and,

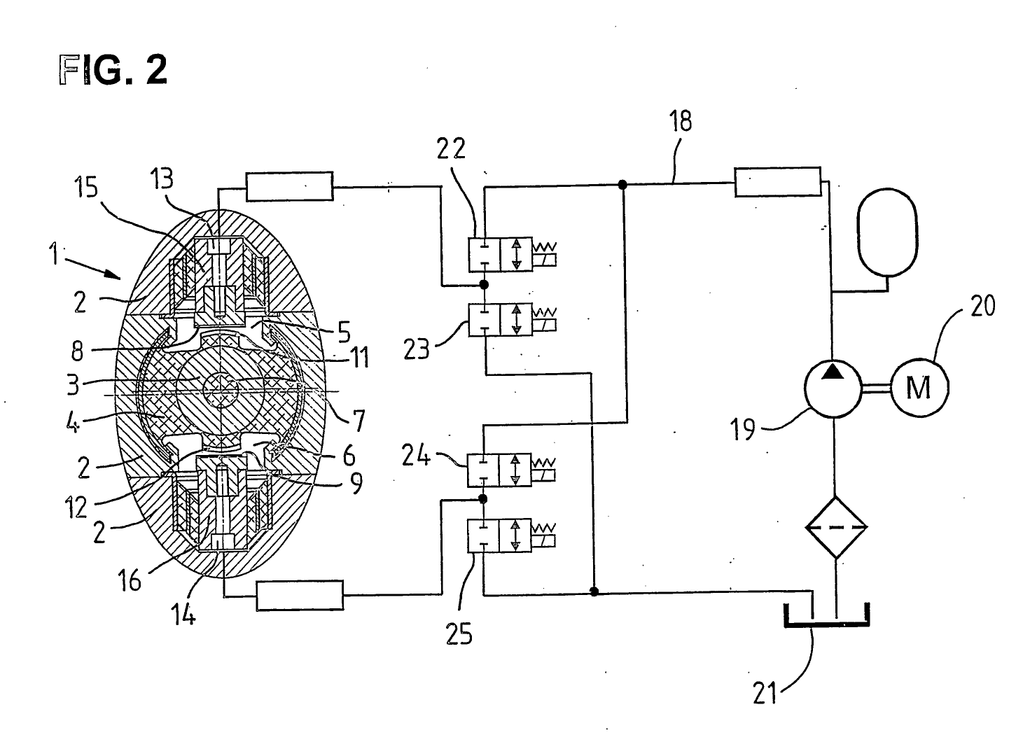

FIG. 2 shows a schematic circuit diagram of a hydraulic control for actuating the stops.

The chassis bearing 1, which is shown in FIG. 1, includes a multi-part outer bearing sleeve 2, an inner bearing sleeve 3 and an elastomer body 4 mounted between the outer and inner bearing sleeves (2, 3). While the elastomer body 4 is connected to the wheel suspension (not shown) via the outer bearing sleeve, the inner bearing sleeve 3 is held in the chassis (not shown) via a bolt 17.

Furthermore, the chassis bearing 1 includes two chambers (5, 6) which are arranged between the outer and inner bearing sleeves (2, 3) and are at least partially delimited by the elastomeric body 4. The chambers (5, 6) are separated from each other and are arranged symmetrically on both sides of the longitudinal axis 7 of the inner bearing sleeve 3.

Each chamber (5, 6) includes a stop (8, 9) which is arranged on a common transverse axis 10 of the inner bearing sleeve 3 and at a distance to a corresponding counterstop surface (11, 12) within the chamber (5, 6).

Each stop (8, 9) is mounted within the chamber (5, 6) on the side which faces toward the outer bearing sleeve 2. In contrast, the corresponding counterstop surfaces (11, 12) are formed within the chambers (5, 6) by the elastomer body 4 and are arranged on the side facing toward the inner bearing sleeve 3.

According to the invention, the stops (8, 9) are configured to be displaceable and are chargeable with pressure in such a manner that they are displaced along the common transverse axis 10 and fix the inner bearing sleeve 3 relative to the outer bearing sleeve 2 in an instantaneous oscillating state. Each stop (8, 9) is configured as an actuating piston (15, 16) which works against a return spring. The actuating pistons (15, 16) can be charged with pressure via hydraulic connections (13, 14). The hydraulic connections (13, 14) have a common feed line 18 for the hydraulic means and are thereby connected to each other quasi in the manner of communicating tubes. In this way, the pressure, which is required for fixing, can only be completely built up when both stops (8, 9) lie in contact engagement against their counterstop surfaces (11, 12).

The chassis bearing 1, which is shown schematically in horizontal longitudinal section in FIG. 1, is assembled in such a manner in the vehicle (not shown) that the common transverse axis 10 points in the direction of travel. The oscillations of the inner bearing sleeve 3 relative to the outer bearing sleeve.2, which occur, for example, when braking, therefore take place essentially along the common transverse axis 3 in travel direction. In order to avoid passing through the disturbing chassis resonances, the actuating pistons (15, 16) are charged with pressure during the braking operation so that the stops (8, 9) are displaced in the direction of the counterstop surfaces (11, 12). In dependence upon the instantaneous oscillating state, a stop 8 can already lie against the corresponding counterstop surface 11 while the other stop 9 is still being displaced in the direction of its corresponding counterstop surface 12. The pressure, which is required for fixing, is only completely built up (that is, built up on the counterstop surfaces (11, 12)), when both stops (8, 9) lie against their counterstop surfaces (11, 12). In this way, the inner bearing sleeve 3 is not displaced actively relative to the outer bearing sleeve 2 by the stop 8 lying first against the counterstop surface 11.

The actuation of the actuating pistons (15, 16) or the stops (8, 9) takes place in dependence upon parameters which describe the oscillations in the chassis bearing 1. These oscillations can, for example, be detected by suitable sensors. It has been shown to be practical that the actuating pistons (15, 16) or the stops (8, 9) are actuated in dependence upon the brake control of a vehicle.

For actuating the actuating pistons (15, 16) or the stops (8, 9), a separate hydraulic system or preferably that of the brake system can be used. When a separate hydraulic system is provided, the possibility advantageously exists that this can be controlled by the brake hydraulic or via the brake control.

In FIG. 2, a schematic circuit of a hydraulic control for actuating the stops (8, 9) is shown.

The illustrated chassis bearing 1 is identical to that from FIG. 1 so that a description thereof is not necessary. The same reference numerals identify the same parts.

To increase the stiffness of the chassis bearing 1, the actuating pistons (15, 16) are charged with pressure via the hydraulic connections (13, 14). A hydraulic pump 19 is used for generating the pressure and this pump is driven by a motor 20. The pump draws the hydraulic medium by suction out of a supply vessel 21 and presses it into a feed line 18. Via correspondingly switched and controlled valves (22, 23, 24, 26), the hydraulic medium is pressed to the hydraulic connections (13, 14) for actuating the actuating pistons (15, 16) or the stops (8, 9). The valves (22, 24) are opened and the valves (23, 25) are closed so that the hydraulic medium connections (13, 14) are connected to each other via corresponding lines in the manner of communicating tubes.

To reduce the stiffness of the chassis bearing 1, the hydraulic medium supply is stopped by closing the valves (22, 24) and the return of the hydraulic medium into the supply vessel 21 is made possible by opening the valves (23, 25). In this way, the actuating pistons (15, 16) or the stops (8, 9) are transferred again into their original start positions via suitable return springs.

### REFERENCE NUMERAL LIST (this is a part of the description)

1 chassis bearing
2 outer sleeve bearing
3 inner sleeve bearing
4 elastomer body
5 chamber
6 chamber
7 longitudinal axis
8 stop
9 stop
10 transverse axis
11 counterstop surface
12 counterstop surface
13 hydraulic connection
14 hydraulic connection
15 actuating piston
16 actuating piston
17 bolt
18 feed line
19 hydraulic pump
20 motor
21 supply vessel
22 valve
23 valve
24 valve
25 valve

1-8. (canceled)

9. A chassis bearing which can be subjected to an oscillating state comprising:
an outer bearing sleeve;
an inner bearing sleeve defining a longitudinal axis and a transverse axis extending transversely to said longitudinal axis;
an elastomeric body arranged between said first and second sleeves;
first and second chambers arranged between said outer and inner bearing sleeves so as to be at least partially delimited by said elastomeric body;
said first and second chambers being separated from each other and being disposed symmetrically on respective sides of said longitudinal axis;
first and second stops displaceably mounted on said transverse axis in corresponding ones of said first and second chambers;
first and second counter stop surfaces formed in corresponding ones of said first and second chambers so as to lie opposite corresponding ones of said first and second stops;
pressure means for applying pressure to said first and second stops so as to permit said first and second stops to be displaced along said transverse axis for fixing said inner bearing sleeve relative to said outer bearing sleeve during said oscillating state; and,
ancillary means for permitting said pressure to be fully built up to a required pressure for effecting said fixing only when both of said stops lie in contact engagement with corresponding ones of said counter stop surfaces.

10. The chassis bearing of claim 9, wherein said pressure is applied utilizing a pressure medium; said first and second stops have first and second connectors for passing said pressure medium to said first and second stops; and, said first and second connectors are connected to each other and have a common feed line for said pressure medium.

11. The chassis bearing of claim 10, wherein said first and second connectors are hydraulic connectors and said pressure medium is a hydraulic medium.

12. The chassis bearing of claim 9, wherein said first and second chambers have respective inner sides facing toward said outer bearing sleeve and respective outer sides facing toward said inner bearing sleeve; and, said first and second stops are arranged in said first and second chambers, respectively, on said respective outer sides and said first and second counter stops are arranged in said first and second chambers, respectively, on said respective inner sides.

13. The chassis bearing of claim 9, further comprising means for resetting said stops.

14. The chassis bearing of claim 13, wherein said resetting means comprises a return spring.

15. The chassis bearing of claim 14, wherein said return spring is a rubber spring.

16. The chassis bearing of claim 13, wherein said first and second stops are configured as first and second actuating pistons operating against said resetting means.

17. The chassis bearing of claim 11, wherein said chassis bearing is mounted in a motor vehicle equipped with a braking arrangement having a hydraulic system; and, said hydraulic connectors are connected to said hydraulic system.

18. The chassis bearing of claim 9, wherein said chassis bearing is mounted in the rear axle of a motor vehicle.
